(19) United States
(12) Patent Application Publication
(10) Pub. No.: US 2020/0001464 A1
(43) Pub. Date: Jan. 2, 2020

(54) SWIMMING ROBOT AND DISPLAY APPARATUS

(71) Applicant: LG ELECTRONICS INC., Seoul (KR)

(72) Inventors: Hyong Guk KIM, Seoul (KR); Jae Young KIM, Seoul (KR); Hyoung Mi KIM, Seoul (KR); Yu June JANG, Seoul (KR); Seung Jong PARK, Gyeonggi-do (KR)

(21) Appl. No.: 16/567,237

(22) Filed: Sep. 11, 2019

Related U.S. Application Data
(63) Continuation of application No. PCT/KR2019/005158, filed on Apr. 29, 2019.

(51) Int. Cl. B25J 11/00; B63H 1/36; B25J 13/08; B25J 19/02; H02J 50/90

(52) U.S. Cl. CPC B25J 11/00; B63H 1/36; H02J 50/90; B25J 19/023; B25J 13/086

(57) ABSTRACT

Disclosed is a display apparatus having a water tank in which one or more swimming robots are located. This apparatus includes a communicator for communicating with a swimming robot or a mobile terminal, a display for displaying a video, and a controller for controlling driving of the swimming robot, wherein the controller receives color information and shape information on the swimming robot through the communicator, and when an item area based on the color information and the shape information on the swimming robot is selected on the video displayed on the display, the controller controls the swimming robot such that the swimming robot moves to the selected item area. Accordingly, interaction between a user, the swimming robot, and the display apparatus may take place.

### CROSS-REFERENCE TO RELATED APPLICATION

This application is a continuation application of PCT Patent Application No. PCT/KR2019/005158, entitled “Swimming robot and display apparatus,” filed on Apr. 29, 2019, in the World Intellectual Property Organization, the entire disclosure of which is incorporated herein by reference.

### BACKGROUND

### 1. Field of the Invention

The present disclosure relates to a swimming robot located in a water tank, and a display apparatus having the water tank.

### 2. Description of Related Art

In general, an aquarium may provide an environment which is inhabited by a variety of aquatic organisms, such as fish, aquatic plants, and the like, thereby providing people who are looking at the aquarium with a sense of emotional security, and providing a resting place with a comfortable atmosphere in a person's residential and cultural life. However, since the objects to be looked at are living organisms, it is essential to manage the aquarium periodically. Accordingly, a significant amount of cost, time, and attention is required in managing, maintaining, and repairing the aquarium. For this reason, an artificial fish robot has been developed, as an alternative to the living organisms in an aquarium.

Korean Patent Application Publication No. 20120127896A, entitled “Robot Fish and Artificial Aquarium Thereof” (hereinafter referred to as “Related Art 1”), discloses a robot fish, consisting of a head portion, a body portion, and a tail portion, which is powered and swims. Related Art 1 also discloses an artificial aquarium that easily provides power by being equipped with a solar cell.

However, although Related Art 1 discloses a robot fish and not living organisms, the robot fish is merely an artificial fish, and since no interaction between the person and the robot fish takes place, the user does not experience any sense of emotional solidarity or identification toward the robot fish.

Korean Patent Application Publication No. 20180076437A, entitled “Smart Fishing Port System Using Transparent Display” (hereinafter referred to as “Related Art 2”), discloses performing communication between a smart fishing port system and a mobile terminal to thereby automatically feed fish in a smart fishing port.

However, although it is disclosed in Related Art 2 that there is interaction between the smart fishing port system and the mobile terminal, the robot fish may not interact with a person or an external device.

### SUMMARY OF THE INVENTION

The present disclosure is directed to providing a swimming robot capable of closely interacting with a person by responding to speech and behavior of the person.

The present disclosure is further directed to providing a swimming robot capable of autonomously monitoring its own power consumption and driving with low power in a specific situation.

The present disclosure is still further directed to providing a display apparatus capable of closely interacting, in various ways, with a smart phone or a plurality of swimming robots located in a water tank.

The present disclosure is still further directed to providing a display apparatus capable of monitoring a state of a swimming robot in real time and efficiently managing power driving of the swimming robot.

The present disclosure is still further directed to providing a display apparatus capable of monitoring a power of a swimming robot and wirelessly charging a swimming robot requiring battery charging.

A swimming robot according to an embodiment of the present disclosure may include various sensing units configured to detect a user behavior, and an input unit for inputting a video signal and an audio signal, thereby enabling close interaction with a user by responding to speech and behavior of the user.

Specifically, the swimming robot may include one or more sensing units configured to detect an event occurring in the user behavior, an input unit for inputting the video signal or the audio signal, a swimming structure unit configured to drive movement of the swimming robot in water, an output unit, a power supply unit, and a control module configured to variously control the above components.

When it is determined, based on information detected by the sensing unit or information inputted through the input unit, that a user command has been inputted, the control module may control the swimming structure unit such that the swimming structure unit performs a movement corresponding to the inputted user command, or may control the output unit such that the output unit performs driving corresponding to the inputted user command.

According to some embodiments, the output unit may include one or more light emitting elements, and the control module may be configured to control the light emitting element such that the light emitting element emits a light emitting pattern corresponding to the inputted user command.

According to some embodiments, the output unit may include a flexible display. The control module may be configured to control the flexible display such that the flexible display displays a video corresponding to the inputted user command.

The swimming robot according to an embodiment of the present disclosure may include an illumination sensor, and when the illumination sensor detects that an illumination value outside a water tank is equal to or less than a predetermined value, the control module may control the swimming structure unit such that the swimming structure unit moves the swimming robot to a wireless charging area provided in a predetermined area of the water tank.

The battery of the swimming robot may be charged in the wireless charging area. Accordingly, the swimming robot may autonomously monitor power driving, and drive with low power in a specific situation.

A display apparatus according to another embodiment of the present disclosure includes a communication unit configured to communicate with a swimming robot or a mobile terminal, and a control module configured to control movement of the swimming robot through the communication unit.

Specifically, the control module may be configured to receive color information and shape information on the swimming robot through the communication unit, and when an item area based on the color information and the shape information on the swimming robot is selected in a video displayed on a display, control the swimming robot such that the swimming robot moves to the selected item area.

A control module of a display apparatus according to embodiments of the present disclosure may monitor a state of charge of each of the swimming robots.

Specifically, the display apparatus according to an embodiment of the present disclosure may guide a specific swimming robot requiring charging to move to a charging area, and may charge a battery of the specific swimming robot when the specific swimming robot is docked to a charging module in the charging area.

The present disclosure is not limited to what has been disclosed hereinabove. A person skilled in the art may clearly understand, from the following description, other aspects not mentioned above.

According to various embodiments of the present disclosure, the following effects can be obtained.

Firstly, a swimming robot capable of closely interact with a person by responding to speech and behavior of the person may be provided, thereby improving a user's convenience and helping a user's emotional development.

Secondly, a swimming robot capable of autonomously monitoring its own power consumption and driving with low power in a specific situation may be provided, thereby enhancing efficiency and stability of the swimming robot.

Thirdly, a display apparatus capable of closely interacting, in various ways, with a smart phone or a plurality of swimming robots located in a water tank may be provided, thereby improving the user's convenience and enabling efficient collaboration between the display apparatus, the smart phone and the plurality of swimming robots.

Fourthly, a display apparatus capable of monitoring a state of the swimming robot in real time and efficiently managing power driving of the swimming robot may be provided, thereby enabling efficient management of the swimming robot.

Fifthly, a display apparatus capable of monitoring a power of the swimming robot and wirelessly charging the swimming robot requiring battery charging may be provided, thereby enabling efficient management of the swimming robot.

### BRIEF DESCRIPTION OF DRAWINGS

FIG. 1 is a view showing an external appearance of a swimming robot having light emitting elements according to one embodiment of the present disclosure.

FIG. 2 is a view showing an external appearance of a swimming robot having a flexible display according to one embodiment of the present disclosure.

FIG. 3 is a block diagram showing a configuration of a swimming robot according to one embodiment of the present disclosure.

FIGS. 4 and 5 are views showing a display apparatus having a water tank according to various embodiments of the present disclosure.

FIG. 6 is a block diagram showing a configuration of a display apparatus having a water tank in which one or more swimming robots are located, according to one embodiment of the present disclosure.

FIG. 7 is a view illustrating the content of an interaction between a user, a display apparatus, and a plurality of swimming robots according to one embodiment of the present disclosure.

FIG. 8 is a view illustrating drivings of one or more swimming robots located in the water tank of FIG. 7.

FIGS. 9 to 14 are views illustrating an interaction between a swimming robot and a display apparatus according to one embodiment of the present disclosure.

FIG. 15 is a sequence diagram illustrating how a display apparatus interacts with a swimming robot, according to one embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

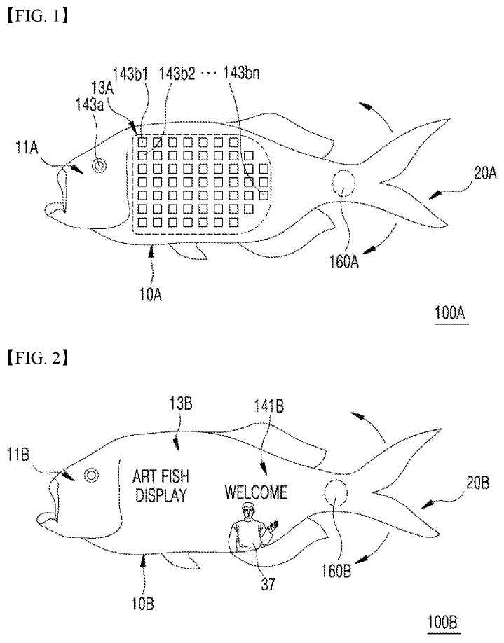

FIGS. 1 and 2 show an external appearance of swimming robots 100A and 100B according to various embodiments of the present disclosure, respectively. The swimming robot may be a robot that swims in water, and may swim in a small fish tank, a large aquarium, a river, the sea, or the like.

Specifically, FIG. 1 shows the external appearance of the swimming robot 100A having light emitting elements according to one embodiment of the present disclosure.

The swimming robot 100A includes a body portion 10A and a tail portion 20A. A swimming structure unit 160 is disposed between the body portion 10A and the tail portion 20A, and the tail portion 20A is moved repeatedly left and right or up and down by the swimming structure unit 160, so that the swimming robot 100A may swim.

Since the swimming structure unit 160 is disposed inside the swimming robot 100A and does not protrude to the outside, a fluid resistance of the swimming robot 100A, which is a swimming object, may be reduced, and the swimming robot 100A may move easily to a desired position. However, the swimming structure unit 160 is not limited to the position 160A indicated FIG. 1, and the swimming robot 100A may include various internal structures and external structures, which are not shown, for easy swimming.

In addition, the body portion 10A may include a head 11A and a body section 13A, and a first light emitting element 143a representing an eye may be disposed on the head 11A. A plurality of first light emitting elements 143a corresponding to left and right eyes of the swimming robot 100A may be implemented. However, the eye of the swimming robot 100A may not be made of the light emitting element, but may instead be made of various materials that may be recognized by a user, or may be omitted.

A plurality of second light emitting elements 143b1 to 143bn may be arranged on the body section 13A of the body portion 10A, and the plurality of second light emitting elements 143b1 to 143bn may be implemented as micro light emitting diodes (LEDs) having a size of 10 to 100 micrometers, respectively, or may be implemented as mini LEDs having a size of 100 to 200 micrometers, respectively. However, although tens of LEDs are shown as being arranged in FIG. 1, tens of thousands of LEDs may be arranged on the body section 13A depending on the size of the LED, and the LED may also be arranged on an area other than the body section 13A at the time of implementation.

FIG. 2 shows the external appearance of the swimming robot 100B having a flexible display according to one embodiment of the present disclosure. Contents that overlap with those described in FIG. 1 will be omitted in the following description of FIG. 2.

The swimming robot 100B may include a flexible display 141B, which forms an overall exterior of a body portion 10B. That is, the flexible display 141B may form both a head 11B and a body section 13B which together constitute the body portion 10B. Although the flexible display 141B is described as forming the body portion 10B without being bent, according to an embodiment, the flexible display 141B is integrally formed so as to include a tail portion 20B, and the tail portion 20B may be implemented to repeatedly bend and straighten when the swimming robot 100B swims.

When the flexible display 141B forms the body portion 10B, all of the eye, gills, an air bladder, and the like on the head 11B may be displayed as a video on the flexible display 141B. In addition, the swimming robot 100B may display various phrases (for example, “ART FISH DISPLAY”) and videos 37 on the flexible display 141B.

When the flexible display 141B is applied to the swimming robot 100B, an organic light emitting diode (OLED), a micro LED, and a mini LED may be mounted on a light source module within the swimming robot 100B, and a configuration including a driving circuit for causing each pixel of the flexible display 141B to display an appropriate color may be included in the swimming robot 100B.

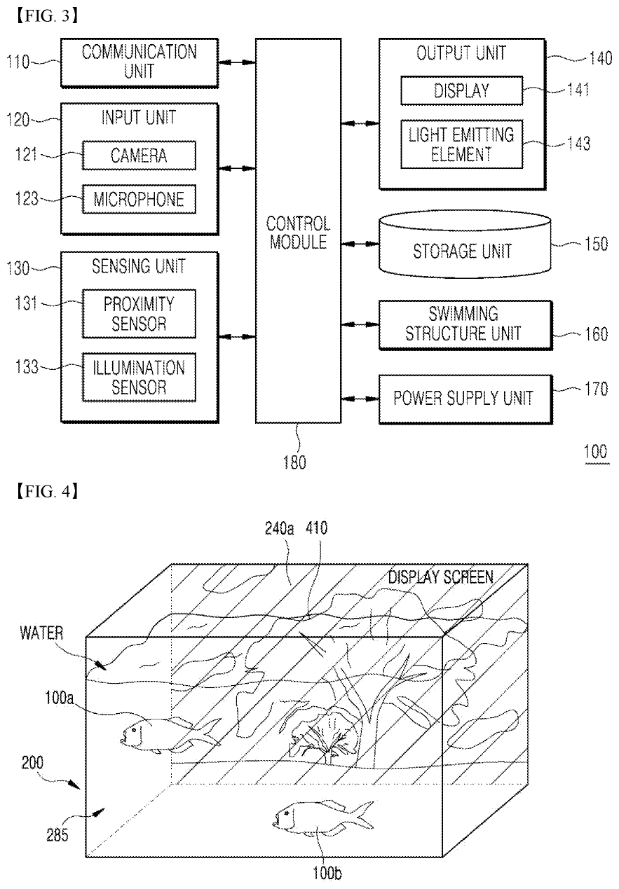

FIG. 3 is a block diagram showing a configuration of the swimming robot 100 according to one embodiment of the present disclosure. The swimming robot 100 may include a communication unit 110, an input unit 120, a sensing unit 130, an output unit 140, a storage unit 150, a swimming structure unit 160, a power supply unit 170, and a control module 180. Since the components shown in FIG. 3 are not essential for implementing the swimming robot 100, the swimming robot 100 disclosed herein may have more or fewer components than those listed above.

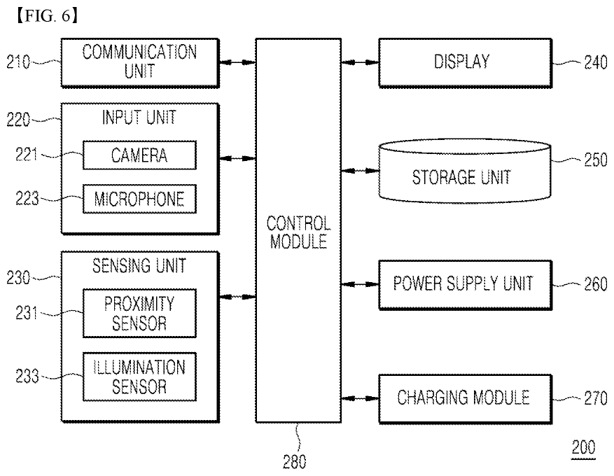

More specifically, the communication unit 110 among the above described components may include one or more wired or wireless communication modules which enable communication between the swimming robot 100 and a mobile terminal, between the swimming robot 100 and a display apparatus (200 in FIG. 6) having a water tank, and between the swimming robot 100 and an apparatus having a communication module. The communication unit 110 comprises at least one of a communicator or the communication unit 110 consists of at least one of a communicator.

The input unit 120 may include a camera 121 or a video input unit from which the input unit 120 receives a video signal, a microphone 123 or an audio input unit from which the input unit 120 receives an audio signal, a code input unit 125 for receiving a bar code or a quick response (QR) code, and a user input unit (for example, a touch key or a mechanical key) for receiving information from a user. Voice data or image data collected by the input unit 120 may be analyzed and then processed as a user's control command. In some implementations, input unit 120 may be implemented inputter or input interface. In some implementations, input unit 120 comprises at least one of inputter or consists of at least one of inputter. In some implementations, input unit 120 may be configured to input data and signals.

The sensing unit 130 may include one or more sensors for detecting at least one of information related to the swimming robot 100 itself, information on the surrounding environment the swimming robot 100, or user information. For example, the sensing unit 130 may include at least one of a proximity sensor 131, an illumination sensor 133, a touch sensor, an acceleration sensor, a magnetic sensor, a gravitational sensor (G-sensor), a gyroscope sensor, a motion sensor, an RGB sensor, an infrared sensor (IR sensor), a finger scan sensor, an ultrasonic sensor, an optical sensor (see, for example, the camera 121), a microphone (see the microphone 123), a battery gauge, an environment sensor (for example, a barometer, a hygrometer, a thermometer, a radiation sensing sensor, a heat sensing sensor, or a gas sensing sensor), or a chemical sensor (for example, an electronic nose, a healthcare sensor, or a biometric sensor). The swimming robot 100 disclosed herein may also combine and utilize information detected by at least two sensors among the sensors described above. The sensing unit 130 comprises at least one of a sensor or consists of at least one of a sensor.

The sensing unit 130 may detect, by using various sensors, a user behavior and an event occurring on the display apparatus (200 in FIG. 6) having the water tank. The user behavior may simply involve approaching the water tank, performing a specific motion, or the like.

The output unit 140 is for generating an output such as a visual output, an audible output, or a haptic output, and may include at least one of a display 141, one or more light emitting elements 143s, a sound output unit, or a haptic module. Since the display 141 may form a mutually layered structure with the touch sensor or may be formed integrally with the touch sensor, the display 141 may be implemented as a touch screen. This touch screen may function as a user input unit for providing an input interface between the swimming robot 100 and the user, and at the same time may provide an output interface between the swimming robot 100 and the user. The output unit 140 comprises at least one of a outputter or consists of at least one of a outputter. The outputter which is configured to output data and signal.

Here, the display 141 may include both a flat display and the flexible display, and the flexible display may be applied to form both the body portion 10B and the tail portion 20B of the swimming robot 100, or may be applied to form only the body portion 10B.

The storage unit 150 stores data for supporting various functions of the swimming robot 100. The storage unit 150 may store a number of application programs (or applications) executed in the swimming robot 100, data for operating the swimming robot 100, and instructions. At least some of these application programs may be downloaded from an external server through a wireless communication. In addition, the storage unit 150 may store user information required to perform the interaction with the swimming robot 100. The user information may be used to identify who a recognized user is. The storage unit comprises at least one of a storage.

The swimming structure unit 160 includes an electrical or mechanical structure unit for driving the movement of the swimming robot 100 in water. The swimming structure unit 160 may include electrical or mechanical equipment for providing swimming power, disposed between the body portion and the tail portion of the swimming robot 100, and may include equipment such as a fin, for enabling easy swimming. The swimming structure unit 160 comprises at least one of a swimming structure or consists of at least one of a swimming structure.

Under the control of the control module 180, the power supply unit 170 is supplied with external power or internal power, and supplies power to each component of the swimming robot 100. This power supply unit 170 includes a battery, which may be an internal battery or a replaceable battery. The power supply unit 170 comprises at least one of a power supplier. In some implementations, the control module 180 may be implemented a controller. In some implementations, the control module 180 comprises at least one of a controller or consists of at least one of a controller.

The battery may be charged in a wired or wireless charging scheme, wherein the wireless charging scheme may include a magnetic induction scheme or a magnetic resonance scheme.

When it is determined, based on information detected by the sensing unit 130 or information inputted through the input unit 120, that a user command has been inputted, the control module 180 may control the swimming robot 100 such that the swimming robot 100 performs a movement corresponding to the inputted user command.

As one example, the control module 180 may detect a user through the sensing unit 130 when the user approaches, control the swimming structure unit 160 such that the swimming robot 100 swims in a specific pattern, control the light emitting element 143 such that the light emitting element 143 emits a specific pattern, and control the display 141 such that the display 141 displays a specific video or phrase. The control unit 180 comprises at least one of a controller.

In addition, the control module 180 may recognize the user command included in the user's speech, and may control the light emitting element 143 such that the light emitting element 143 emits a light emitting pattern corresponding to the user command, or display a video corresponding to the user command on the display 141.

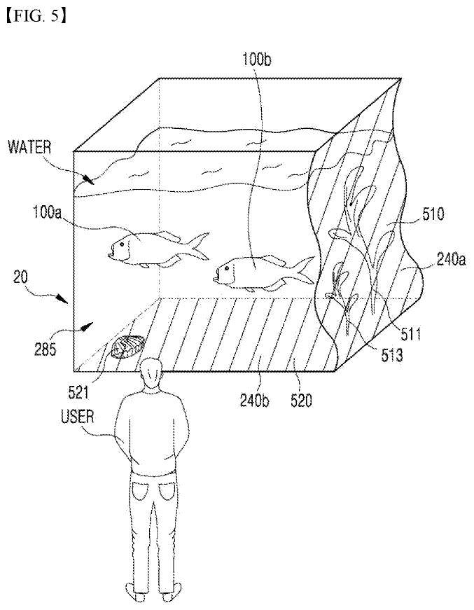

FIGS. 4 and 5 show a display apparatus 200 having a water tank according to various embodiments of the present disclosure. Here, the water tank may include a small fish tank, an aquarium, and the like, but the embodiments are not limited thereto.

FIG. 4 shows the display apparatus 200 having the water tank 285 in which the swimming robots 100a and 100b are located, wherein a flat display 240a is applied to the display apparatus 200.

The water tank 285 of the display apparatus 200 may be formed in a hexahedron shape, and a display 240a for displaying the video may be disposed on one surface of the water tank 285.

In addition, the swimming robots 100a and 100b are swimming in the water tank 285, and the inside of the water tank 285 may be filled with liquid. The liquid may be common water. However, the liquid to be filled in the water tank 285 may include water mixed with distilled water, Clorox® or vinegar, or ethanol for disinfection, and when there is no possibility of ingestion by a human, water mixed with Clorox®, colorless and inviscid liquid such as liquid paraffin, or antiseptic such as phenoxyethanol, or the like.

When a specific item 410 indicated on the video displayed on a display 240a moves, each of the swimming robots 100a and 100b shown in FIG. 4 may detect the moving specific item 410 through the sensing unit, and move to follow the moving specific item 410. That is, the swimming robots 100a and 100b may track the movement of the specific item 410 included in the video and follow the specific item 410, and may perform various displays through the output unit.

FIG. 5 shows the display apparatus 200 having a curved display.

Referring to FIG. 5, the display apparatus 200 may include the water tank 285 in which the swimming robots 100a and 100b are located, and may include the display 240a and display 240b disposed on a plurality of surfaces 510 and 520. The plurality of displays may include the flexible display 240a, the flat display 240b, and the like.

Marine organisms 511 and 513 such as coral may be displayed on the flexible display 240a, and shellfish 521 may be displayed on the flat display 240b. However, there is no limitation as to the contents of the displayed video.

The user is looking at the water tank 285, and the first swimming robot 100a may detect the approach of the user, photograph the user using the photographing unit, recognize the photographed user based on previously stored user information when the photographed video signal is inputted through the input unit, and perform driving corresponding to the recognized user.

For example, when the user approaches the first swimming robot 100a at a close distance, the first swimming robot 100a may swim in a predetermined pattern and emit a specific light emitting pattern by means of the light emitting element.

FIG. 6 is a block diagram showing a configuration of the display apparatus 200 having the water tank in which one or more swimming robots are located, according to one embodiment of the present disclosure.

Referring to FIG. 6, the display apparatus 200 includes a communication unit 210, an input unit 220, a sensing unit 230, a display 240, a storage unit 250, a power supply unit 260, a charging module 270, and a control module 280. Since the components shown in FIG. 6 are not essential for implementing the display apparatus 200, the display apparatus 200 described herein may have more or fewer components than those listed above. In addition, in describing FIG. 6, description of the same or similar contents as those of FIG. 3 may be omitted.

The communication unit 210 may communicate with the swimming robot or the mobile terminal. Here, the mobile terminal may be included within the control range of the user.

The display 240 may be an area for displaying the video, use various types of displays in addition to the flat display, and be disposed on a plurality of surfaces in addition to a specific one surface of the water tank.

The charging module 270 may include a wireless charging module, and may charge a battery of the swimming robot 100 under the control of the control module 280, when the swimming robot 100 moves to a predetermined charging area provided in the water tank and completes a docking for charging in the charging area (for example, when a wireless transmission unit and a wireless reception unit are aligned). Schemes such as the magnetic induction scheme and the magnetic resonance scheme may be applied to wireless charging.

The control module 280 may recognize a user command in an audio signal inputted through the input unit 220, and control the swimming robot 100 such that the swimming robot 100 performs driving corresponding to the user command. Here, “control” may mean transmission of a control command to the swimming robot 100 by the display apparatus 200. In some implementations, the control module 280 may be implemented a controller. In some implementations, the control module 280 comprises at least one of a controller or consists of at least one of a controller.

For example, when the user speaks “Hi”, the control module 280 may recognize the user command in the audio signal inputted through a microphone 223. The control module 280 may recognize a predetermined user command in the user's speaking of “Hi”, and cause the swimming robot 100 to display a specific video or a specific phrase on the display 140 thereof.

The control module 280 may control the movement of the swimming robot through the communication unit 210. The control module 280 may provide information on each point (or pixel) of the display 240 to the swimming robot 100, and provide three-dimensional spatial information on each point of the water tank to the swimming robot in order to control the swimming robot such that the swimming robot moves to a specific point of the water tank.

The control module 280 may receive color information and shape information (including size information, form information, and the like) on the swimming robot 100 through the communication unit 210, and may select, on the video displayed on the display 240, an item area based on the color information and the shape information on the swimming robot. That is, the control module 280 may select the item area corresponding to the color and shape of the swimming robot on the display 240.

In this case, the control module 280 may control the swimming robot 100 such that the swimming robot 100 moves to the selected item area, and the control module 280 may provide position information on the item area to the swimming robot 100.

When the swimming robot 100 moves to the selected item area, the control module 280 may control the swimming robot such that the swimming robot reflects the color information and the shape information on the item. That is, the control module 280 may cause the swimming robot to reflect the color information and the shape information (including the size information and the form information) on a specific portion of the display 240.

As a result, the swimming robot 100 is driven such that, from the perspective of the user, the swimming robot 100 appears to come out of the display 240. In this way, interaction between the user, the swimming robot, and the display 240 may take place.

In this case, the control module 280 may cause the item area applied to the swimming robot 100 to disappear from the video on the display 240. As a result, the effect of the swimming robot 100 appearing to come out of the display 240 can be more prominent to the user.

Here, the video displayed on the display 240 may be a video received from the mobile terminal through the communication unit 210. Accordingly, interaction between the mobile terminal and the display apparatus 200 may take place.

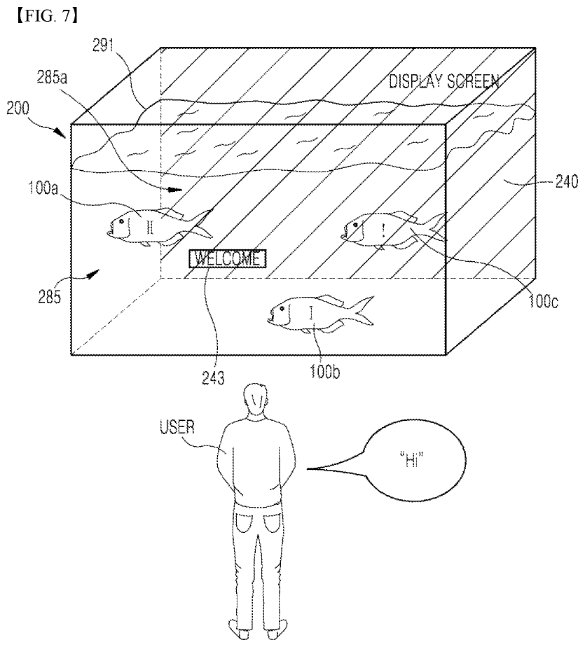

FIG. 7 is a view illustrating the content of the interaction between the user, the display apparatus 200, and a plurality of swimming robots 100a to 100c according to one embodiment of the present disclosure.

Referring to FIG. 7, first, the water tank 285 may be filled up to a predetermined line 291 with water, distilled water, or the like. In this case, the water tank 285 may be filled with a material for further increasing the buoyancy velocity of the swimming robots 100a to 100c.

The display apparatus 200 may provide the display 240 on one surface 285a of the water tank 285, and the display 240 may interact with the user and the swimming robots 100a to 100c. The display apparatus 200 may communicate with the swimming robots 100a to 100c, and control the swimming robots 100a to 100c such that the swimming robots 100a to 100c are driven to perform a specific movement or a specific output.

The display apparatus 200 may recognize a specific user command (for example, “Hi”). The display apparatus 200 may include the input unit 220, such as the microphone 223, to detect the voice of the user, and may recognize the user command through the voice.

In this case, the display apparatus 200 may display the phrase “WELCOME” 243 or display various videos on the display, and may control each of the swimming robots 100a to 100c such that each of the swimming robots 100a to 100c displays the letters “H”, “I”, and “!”, respectively.

Specifically, the display apparatus 200 may communicate with each of the swimming robots 100a to 100c individually to cause each of them to display a specific phrase, and may display a specific video instead of the specific phrase on the display of each of the swimming robot 100a to 100c, according to the implementation.

In addition, the display apparatus 100 may control each of the swimming robots 100a to 100c individually to transmit commands relating to various clustering methods to each of the swimming robots 100a to 100c, thereby providing various visual effects.

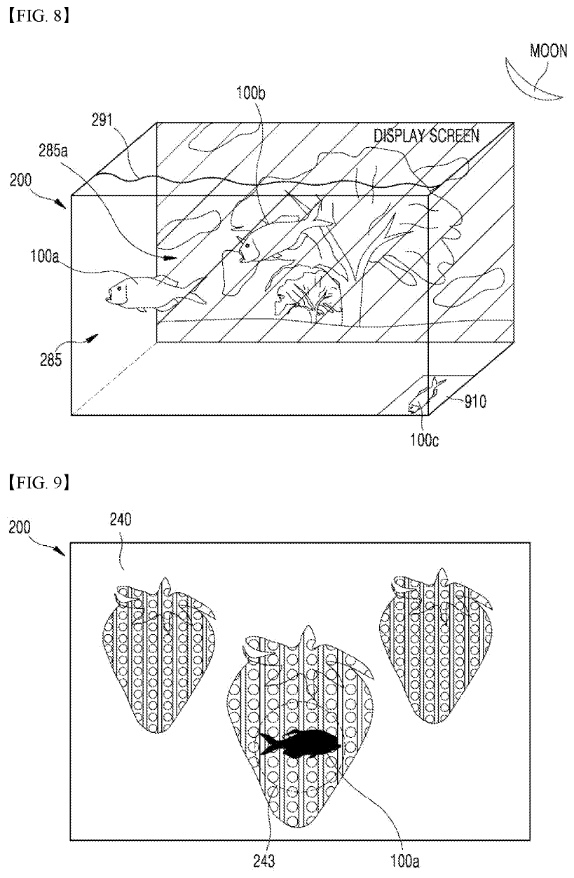

FIG. 8 is a view illustrating driving of one or more swimming robots 100a to 100c located in the water tank 285 of FIG. 7.

When the illumination sensor detects that the illumination value of the water tank 285 is equal to or less than the predetermined value, each of the swimming robots 100a to 100c may control the swimming structure unit thereof such that the swimming structure unit drives with a predetermined power or less.

Here, when an outdoor illumination is used as a reference, the illumination value being the predetermined value or less may be set to the illumination value of night time, without sunshine (6:00 am to 7:00 pm). Alternatively, when an indoor illumination is used as the reference, the illumination value being the predetermined value or less may be set to the illumination value when an indoor lighting is turned off. However, other settings are possible according to the implementation.

In addition, the power being at a predetermined power or less may refer to the power being in a low power state, but the predetermined power may have a different range according to the embodiment.

When the illumination sensor detects that the illumination value outside the water tank 285 is equal to or less than the predetermined value, a third swimming robot 100c may move to a wireless charging area provided in a predetermined area of the water tank for charging.

In this embodiment, the display apparatus 200, in addition to the swimming robot, may monitor a state of charge of each of the swimming robots 100a to 100c individually, control a specific swimming robot requiring charging such that the specific swimming robot requiring charging moves to the charging area 910, and charge the battery of the specific swimming robot when the specific swimming robot is docked to the charging module in the charging area. If a plurality of swimming robots require charging at the same time, the plurality of swimming robots may be charged at the same time, according to scheduling.

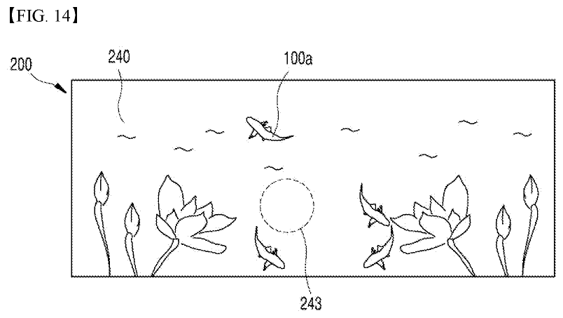

FIGS. 9 to 14 are views illustrating the interaction between the swimming robot 100a and the display apparatus 200 according to one embodiment of the present disclosure. FIGS. 9 to 11 are views illustrating the interaction between the swimming robot 100a and the display apparatus 200 according to one scenario, and FIGS. 12 to 14 are views illustrating the interaction between the swimming robot 100a and the display apparatus 200 according to another scenario.

Referring to FIG. 9, the display apparatus 200 displays one video on the display 240. The video may be a video received through an external mobile terminal, but may also be a video displayed through another source, or a video displayed autonomously. In addition, it is assumed that the swimming robot 100a forms an external appearance of a specific color (black).

The swimming robot 100a may provide the color information and the shape information (including the size information, the form information, and the like) to the display apparatus 200 through the communication unit. Here, the color information may include color information that may be displayed on the flexible display of the swimming robot 100a, information on an area where the color information is displayed, and the like. The display apparatus 200 may provide, to the swimming robot 100a through the communication unit, information on a specific point 243 to which the swimming robot 100a is to move.

Here, the information on the specific point 243 is information on the item area 243 in which the video corresponding to the swimming robot 100a exists. The display apparatus 200 may cause the swimming robot 100a to move to the specific point 243 of the display 240. In this case, the display apparatus 200 may set, as a specific point, a specific area that may be projected as the specific point 243, even if the specific area is at a distance from the display 240 within the water tank.

The display apparatus 200 may cause a part of the item area 243 or the entire item area 243 to be applied to the swimming robot 100a. That is, the display apparatus 200 may cause the entire item area 243 to be reflected on the swimming robot 100a, or cause only a part of the item area 242 to be reflected on the swimming robot 100a.

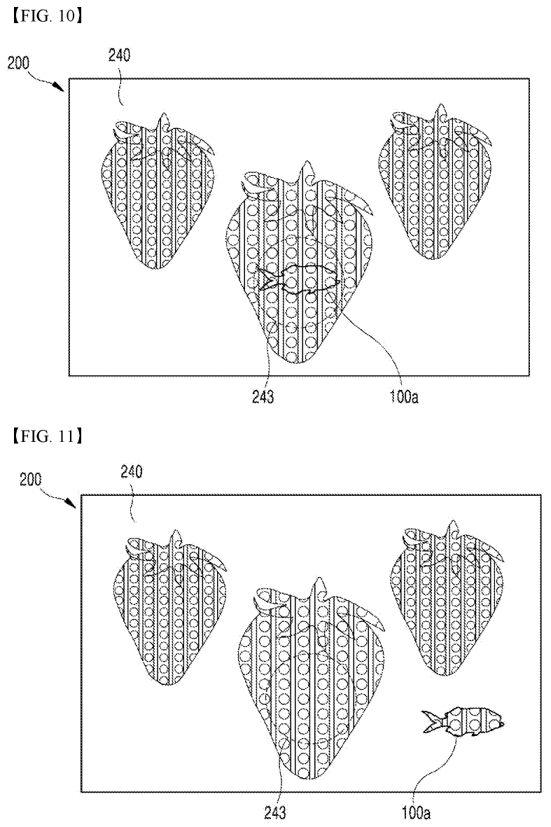

Referring to FIG. 10, the display apparatus 200 may change the color information and the shape information of the swimming robot 100a based on the color information and the shape information of the item area 243.

To this end, the display apparatus 200 may perform video processing such that the three-dimensional swimming robot 100a is projected two-dimensionally on the surface of the display 240, and may control the swimming robot 100a such that the swimming robot 100a changes the external appearance thereof based on the color information and the shape information (including the size information, the form information, and the like) corresponding to the projected video.

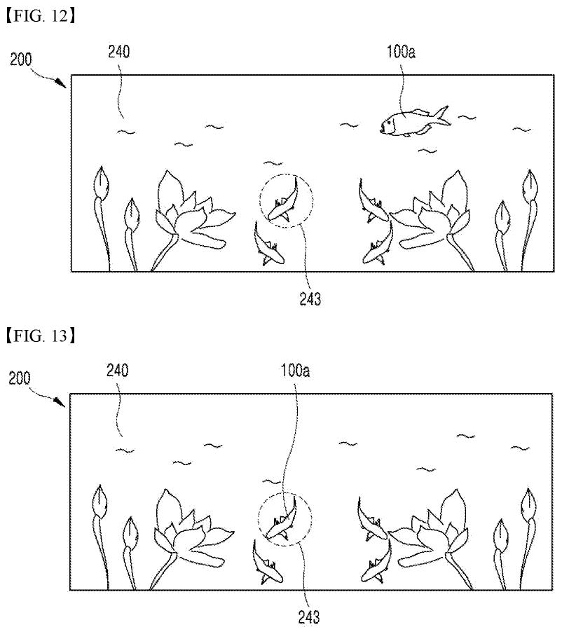

Referring to FIG. 11, the swimming robot 100a may swim with the specific video of the display 240 reflected on the exterior thereof. Accordingly, the user may experience an effect in which the swimming robot 100a appears to come out of the video of the display 240, thereby helping the user's emotional development.

Hereinafter, FIGS. 12 to 14 will be described, but description of the same or similar contents as those of FIGS. 9 to 12 will be omitted.

There may be a difference between the color information and the shape information displayed on the flexible display of the swimming robot 100a and the color information and the shape information displayed on the display 240 of the display apparatus 200, and the display apparatus 200 may set the color information and the shape information that may be reflected on the swimming robot 100a.

The display apparatus 200 may control the swimming robot 100a such that the swimming robot 100a moves to the item area 243, and changes according to the color information and the shape information of the fish in the item area 243 when the swimming robot 100a moves to the item area 243. That is, the swimming robot 100a may include the flexible display, to which the color information and the shape information of a smaller object may be applied.

Referring to FIG. 14, when the swimming robot 100a moves out of the item area 243, the display apparatus 200 may perform video processing such that the color information and the shape information on the fish in the item area 243 disappear, and may set the color of the item area 243 to the surrounding dominant color.

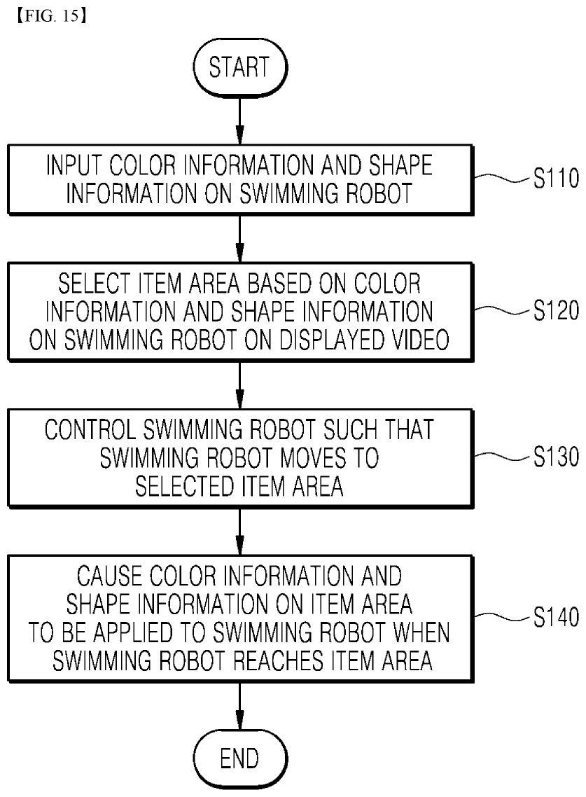

Hereinafter, how the display apparatus 200 interacts with the swimming robot according to one embodiment of the present disclosure will be described with reference to FIG. 15.

First, the display apparatus 200 receives the color information and the shape information on the swimming robot (S110).

Here, the color information may include information on a color that the swimming robot may express, position information on a pixel on which the color is expressed, and the like. The shape information may include information on the shape, information on the form, and information on the size.

Next, the display apparatus 200 selects an item area based on the color information and the shape information on the swimming robot in the displayed video (S120).

The selected item area may be an item on the video of the display 240.

The display apparatus 200 may select, as the item area, an area of the two-dimensional display on which the shape information on the three-dimensional swimming robot is projected. Accordingly, a seamless video process may be performed between the video displayed on the display 240 and the video displayed on the flexible display of the swimming robot 100.

Thereafter, the selected display apparatus 200 controls the swimming robot such that the swimming robot moves to the item area (S130).

Finally, the display apparatus 200 causes the color information and the shape information on the item area to be applied to the swimming robot, when the swimming robot reaches the item area (S140).

Accordingly, the user may experience an esthetic sense in which the swimming robot appears to come out of the video displayed on the display apparatus 200.

The present disclosure described above may be embodied as computer-readable code on a computer-readable medium. The computer-readable medium includes any type of recording device capable of storing data which may be read by a computer system. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like, and the computer may include a control module 180 of the swimming robot 100 or the control module 280 of the display apparatus 200.

Although specific embodiments of the present disclosure have been shown and described above, the present disclosure is not limited to the specific embodiments described, and those skilled in the art will appreciate that various modification and changes may be made therein, without departing from the scope and spirit of the present disclosure. Therefore, the scope of the present disclosure should not be limited by the embodiments described but should be determined by the technical idea described in the claims.

What is claimed is:

1. A swimming robot located in a water tank having a display, comprising:
one or more sensors configured to detect a user behavior or an event occurring on the display;
an inputter for inputting a video signal or an audio signal;
a swimming structure configured to drive movement of the swimming robot in water;
an outputter;
a power supplier; and
a controller,
wherein when it is determined, based on information detected by the sensor or information inputted through the inputter, that a user command has been inputted, the controller controls the swimming structure such that the swimming structure performs a movement corresponding to the inputted user command, or controls the outputter such that the outputter performs driving corresponding to the inputted user command.

2. The swimming robot according to claim 1,
wherein the outputter comprises one or more light emitting elements, and
wherein the controller is configured to control the light emitting element such that the light emitting element emits a light emitting pattern corresponding to the inputted user command.

3. The swimming robot according to claim 1,
wherein the outputter comprises a flexible display, and
wherein the controller is configured to control the flexible display such that the flexible display displays a video corresponding to the inputted user command.

4. The swimming robot according to claim 1,
wherein the sensor comprises an illumination sensor,
wherein the power supplier is provided with power by means of a battery, and
wherein when the illumination sensor detects that an illumination value outside the water tank is equal to or less than a predetermined value, the controller controls the swimming structure such that the swimming structure moves the swimming robot to a wireless charging area provided in a predetermined area of the water tank, and charges the battery in the wireless charging area.

5. The swimming robot according to claim 4,
wherein when the illumination sensor detects that the illumination value outside the water tank is equal to or less than the predetermined value, the controller controls the swimming structure or the outputter such that the swimming structure or the outputter drives the swimming robot with a predetermined power or less.

6. The swimming robot according to claim 1,
wherein when a video, in which a user located within a predetermined distance is photographed, is inputted through the inputter, the controller recognizes the user in the photographed video based on user information stored in a storage, and controls the swimming structure or the outputter such that the swimming structure or the outputter performs driving corresponding to the recognized user.

7. The swimming robot according to claim 1,
wherein when a predetermined item included in a video displayed on the display moves, the controller detects the moving item through the sensor, and controls the swimming structure such that the swimming structure moves the swimming robot to follow the moving item.

8. A swimming robot configured to interact with a display apparatus having a water tank, comprising:
a communicator configured to communicate with the display apparatus or a mobile terminal;
a swimming structure configured to drive movement of the swimming robot in water;
a flexible display forming an exterior of the swimming robot; and
a controller configured to provide color information and shape information on the swimming robot to the display apparatus through the communicator,
wherein when the controller receives, through the communicator, information on a specific point on the display apparatus to which the swimming robot is to move, the controller controls the swimming structure such that swimming structure moves the swimming robot to the specific point.

9. The swimming robot according to claim 8,
wherein when an item area corresponding to the swimming robot is selected in a video displayed on the display apparatus, the controller receives, from the display apparatus, color information and shape information on the item area through the communicator, and
wherein the color information and the shape information on the item area are applied to the flexible display.

10. The swimming robot according to claim 9,
wherein the controller controls the swimming structure such that the swimming structure moves in a predetermined pattern.

11. A display apparatus having a water tank in which one or more swimming robots are located, comprising:
a communicator configured to communicate with the swimming robot or a mobile terminal;
a display configured to display a video; and
a controller configured to control driving of the swimming robot,
wherein the controller is configured to:
receive color information and shape information on the swimming robot through the communicator, and
when an item area based on the color information and the shape information on the swimming robot is selected on the video displayed on the display, control the swimming robot such that the swimming robot moves to the selected item area.

12. The display apparatus according to claim 11,
when the swimming robot moves to the selected item area, the controller applies color information and shape information on the item area to the swimming robot.

13. The display apparatus according to claim 12,
wherein the controller is configured to control the display such that the item area applied to the swimming robot disappears from the video.

14. The display apparatus according to claim 11,
wherein the video displayed on the display is a video received from the mobile terminal through the communicator.

15. The display apparatus according to claim 11,
wherein the controller is configured to control each of the one or more swimming robots such that each of the one or more swimming robots performs an individual movement or output.

16. The display apparatus according to claim 11,
wherein a charging area is disposed in a predetermined area of the water tank, and
wherein the controller is configured to:
monitor a state of charge of each of the swimming robots, and control a specific swimming robot requiring charging such that the specific swimming robot requiring charging moves to the charging area, and
charge a battery of the specific swimming robot when the specific swimming robot is docked to a charging module in the charging area.
